(19) United States
(12) Patent Application Publication
(10) Pub. No.: US 2008/0088440 A1
(43) Pub. Date: Apr. 17, 2008

(54) Wireless remote assistance

(76) Inventor: Simon Palushaj, Shelby Township, MI (US)

Correspondence Address: REISING, ETHINGTON, BARNES, KISSELLE, P.C., P O BOX 4390, TROY, MI, 48099-4390, US

(21) Appl. No.: 11/581,826

(22) Filed: Oct. 17, 2006

(51) Int. Cl. G08B 1/08; H04Q 7/00

(52) U.S. Cl. 340/539.25; 340/539.18

(57) ABSTRACT

A method of providing real time remote assistance to a user (12) through a remote assistance system (10) that includes a wireless communication device (20) for two way audio and at least one way video communication. The system (10) receives an activation signal from device (20) to connect to the system (10). The needs of user (12) are assessed and device (20) is then directly connected to a selected support technician (14) who can speak to the user and view a project (16) or the user (12) to expedite assistance to user (12).

### TECHNICAL FIELD

The field of this invention relates to a method for providing remote assistance to a user through a wireless communication system.

### BACKGROUND OF THE DISCLOSURE

Consumers often have questions about the products and services they purchase and use. So, many industries provide some type of support to their customers. Such support may come from a traditional telephone support center, where trained technicians answer calls from consumers regarding a company's products. And some companies provide support through useful websites that guide customers through common problems and answer common questions. The computer industry, for example, is able to offer more advanced solutions, such as remotely controlling a customer's PC to allow a technical support technician to fix a problem for the customer. Remote assistance may take many forms, including simple voice communications over a telephone system between a user and a support technician. For example, a knowledgeable person responsible for answering questions pertaining to a particular product may be reached by telephone. Remote assistance may also be provided using various wireless communication systems. For example, cellular phones enable users to reach voice-only remote assistance systems in remote areas where cellular phone service is available.

In some industries, customers may have a difficult time explaining their problem as they may be unfamiliar with the subject matter. The do-it-yourself (DIY) home improvement industry is one such example. Many more DIY products are available that are aimed to make construction, repair projects and specialized repair tasks within the realm of a homeowners capabilities. As a result, many more customers are attempting to do more extensive and complicated home improvement projects, and may require more detailed assistance. In many cases, customers are unfamiliar with proper names for tools, equipment, materials, and industry jargon. And many of these customers may simply be unable to adequately explain their problem to a technical support technician over the phone. The technical support technician may be unable to talk the customer through the solution without actually seeing what the customer is doing. A customer who cannot verbally explain their situation may be able to point and show the problem to a technical support technician. Similarly, the technician may need to see what the customer is doing, what the problem actually looks like, or may need to see more of the area in order to properly help the customer. But bringing a support technician into a customer's home is not always practical, economical, or convenient and defeats the entire concept of the DIY industry.

Many companies employ technical support technicians that are experts in one particular area. But customers may reach one technician, but need the experience of another to answer their question. In many cases, when a user calls a support center for help, this process involves transferring the call from one person or location to another. This process may become frustrating or inefficient when the customer has trouble clearly identifying the problem or question. Also, operators may make assumptions about the nature of the problem or question when they are unable to view the work area.

What is needed is a system that offers both voice and video communication to provide additional advantages to voice-only remote assistance systems like telephone and cellular phone systems.

### SUMMARY OF THE DISCLOSURE

In accordance with one aspect of the invention, a method of providing real-time remote assistance has a user with a wireless communications device that provides two-way audio communication and at least one way video communication through a remote assistance system. Preferably, wireless communication device is received from the user during a check-out procedure in a retail store. The wireless communications device may be loaned or rented to the user. An activation signal from the wireless communications device is received by the remote assistance system. The wireless communications device becomes connected to the remote assistance system wherein the connection enables communication of both audio and video signals with the wireless communications device. The user's needs are assessed and a support technician is selected to meet the user's needs. The technician is placed in audio communication directly with the user, wherein the technician can also view the video signal through the wireless communications device.

The method may provide real-time remote assistance from a plurality of technicians to a plurality of users, wherein each user has a wireless communications device.

In one embodiment, the wireless communications device may be a mobile communicator that includes a webcam having pan, tilt, and zoom capabilities. The activation signal may be received by a server that registers the wireless communications device with a DDNS service. The activation signal may cause a notification message to be sent to the support technician. The notification message may include at least one information item from a group comprising: personal user information, user assistance request, an IP address, a FQDN, and a status message.

The wireless communications device may be connected through the internet to the remote assistance system. In one embodiment, a live operator may speak with the user, view the user's work space, and assesses the type of assistance and the level of competency that the user requires. The operator then selects a support technician by an area of expertise and a competency level. The area of expertise of the technician may be either plumbing, electrical, roofing, building, decking, flooring, painting, tiling, kitchen, bathroom, or HVAC. The support technician may provide remote assistance to the user through a mobile communicator that has a battery pack contained therein. The support technician provides a service for example, quoting a price for work to be done, providing step-by-step instructions, helping with tool selection, helping with material selection, providing cost estimation, aiding in problem solving, and discussing solution alternatives.

In this fashion, a remote assistance system can provide a decentralized system that allows a plurality of users to address a numerous and varied concerns and problems to a plurality of technicians who are adept at a particular skill through an audio and at least one-way video connection.

### BRIEF DESCRIPTION OF THE DRAWINGS

Reference now is made to the accompanying drawings in which:

FIG. 1 is a block diagram depicting an exemplary embodiment of a communications system namely a remote assistance system that is capable of utilizing the remote assistance methods disclosed herein;

FIG. 2 is a block diagram depicting a mobile communicator that is capable of utilizing the remote assistance methods disclosed herein;

FIG. 3 is a flow chart depicting one embodiment of the invention; and

FIG. 4 is a flow chart depicting another embodiment of the invention.

### DETAILED DESCRIPTION OF PREFERRED EMBODIMENTS

The disclosed methods use a wireless communication system to provide remote assistance to a user. A user may be any person that desires remote assistance. For example, a user may be a customer of a home improvement store that intends to perform a home improvement project. A user may also be a person that desires quotes or bids for a particular project and desires remote assistance for assessing the cost, complexity, alternative ideas, and project estimates from potential contractors.

The wireless communication system and method provide remote assistance to a user through a decentralized system. Generally, a centralized system is one where the communications are aggregated into a central location, like telephone calls to a technical support call center. A decentralized system is one where the communication channel is open to any available support person regardless of location, such as an interactive internet website.

### Wireless Communication System—

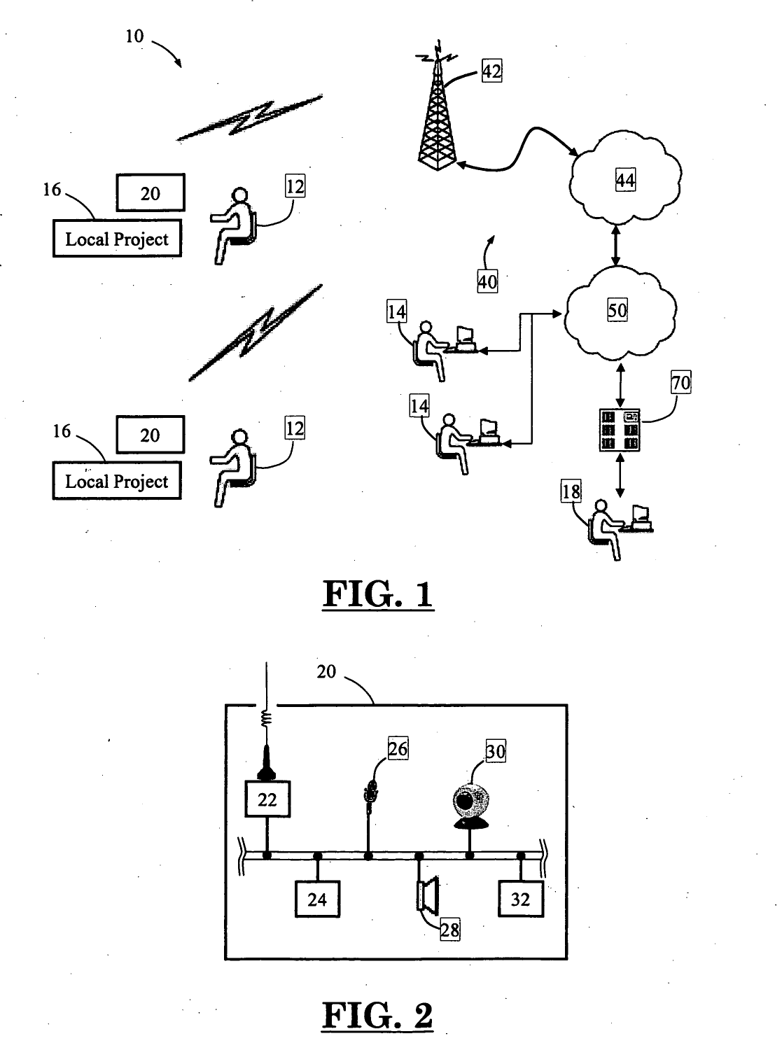

FIG. 1 illustrates one example of a wireless communication system that is capable of utilizing the disclosed remote assistance methods. A remote assistance system 10 generally provides wireless voice and video communication between a user 12 and a support technician 14. System 10 provides communication between user 12 and support technician 14, and generally includes a wireless communication device hereinafter referred to as a mobile communicator 20, a wireless network 40, a land network 50, and a server 70. It should be understood that the disclosed methods can be used with any number of different wireless communication devices, and used to connect any number of users 12 with any number of support technicians 14. Only two communicators 20, users 14 and support technicians 14 are shown for simplicity of the drawing. Also, the overall architecture, setup, and operation, as well as the individual components, of a system such as that shown here are generally known in the art. Thus, the following paragraphs simply provide a brief overview of one such exemplary system 10; however, other systems not shown here could employ the disclosed methods as well.

User 12 generally utilizes mobile communicator 20 to communicate with support technician 14. User 12 may be working with a local project 16, such as a home improvement project, and desire assistance from support technician 14. User 12 can use mobile communicator 20 within system 10 to communicate with support technician 14 using both voice and video communications. For example, user 12 can show support technician 14 local project 16 using video communication while simultaneously engaging in a voice conversation.

Mobile communicator 20 preferably uses radio transmissions to communicate with wireless network 40 in order to provide user 12 with wireless voice and video communication services. Wireless network 40 is preferably a cellular telephone system that provides wireless broadband data services, but could be any other suitable wireless system. According to an exemplary embodiment, wireless network 40 includes one or more cell towers 42, base stations and/or mobile switching centers (MSCs) 44, as well as any other networking components required to connect wireless network 40 with land network 50. According to an exemplary embodiment, wireless network 40 is a CDMA wireless network that provides wireless broadband data services such as EVDO.

Land network 50 may be a conventional land-based telecommunications network that is connected to one or more landline networks and connects wireless network 40 to internet accessible devices, servers 70, and other services. For example, land network 50 may include a public switched telephone network (PSTN) and/or a TCP/IP network, as is appreciated by those skilled in the art. Of course, one or more segments of land network 50 could be implemented through the use of a standard wired network, a fiber or other optical network, a cable network, power lines, other wireless networks such as wireless local area networks (WLANs), or networks providing broadband wireless access (BWA), or any combination thereof.

Server 70 may provide one or more services to facilitate the disclosed methods. Server 70 may provide an internet accessible website that allows support technicians 14 to view the status of various mobile communicators 20. Server 70 may also provide information related to a support request from user 12. In one embodiment, mobile communicator 20 connects to server 70 that performs an initial screening of user 12. After the initial screening an appropriate technician 14 may be connected with user 12. An initial screening may be automated or may be handled by an operator 18. In an automated system, server 70 may provide voice menus to user 12, thereby allowing user 12 to select an appropriate support technician 14. Server 70 may also provide more technical services, such as dynamic domain name system (DDNS) services for mobile communicators 20. Since mobile communicator 20 may receive a dynamic IP address, server 70 may use DDNS to assist support technician 14 in locating a particular mobile communicator 20. Server 70 may also provide a database of support technicians 14. Such a database may contain details about each support technician 14, or may simply include broad identifiers about the technician's area of expertise and experience level. The database may also be updated with availability info such that operator 18 can search the database for available support technicians 14 that can provide appropriate assistance to user 12.

### Mobile Communicator—

FIG. 2 illustrates one embodiment of mobile communicator 20. Mobile communicator 20 is generally a mobile communications unit that provides both voice and video communications. Although voice communication is preferably 2-way, video communication may be one way, providing a video feed from user 12 to support technician 14. Generally, mobile communicator 20 includes a wireless signaling device 22, a computing device 24, a microphone 26, a speaker 28, a video camera 30, and a power supply 32. Although mobile communicator 20 may be a single unit, it may also be composed of several interconnected internal or external components that provide both voice and video communication over a wireless network. Mobile communicator 20 may also include additional devices such as a keyboard, a video display, an LCD screen, a text-only display, and a global positioning system (GPS) receiver to name but a few.

Wireless signaling device 22 preferably uses radio transmissions to establish a communications channel (a voice channel and/or a data channel) with wireless network 40 so that voice and/or data transmissions can be sent and received over the channel. By providing both voice and data communication, mobile communicator 20 can offer a number of different services related to remote assistance. For example, mobile communicator 20 may provide voice and data communication, voice over IP (VOIP), text-based instant messaging, SMS messaging, graphic display, presentation display, and other remote assistance services. According to one embodiment, wireless signaling device 22 includes a wireless modem for data transmission. The modem may operate using any number of different standards or protocols such as EVDO, CDMA, GPRS, EDGE, WiFi, and WiMAX to name but a few. Wireless signaling device 22 may also include a standard cellular chipset for voice communications over wireless network 40. In one embodiment, wireless signaling device 22 is a router that provides local wireless connections over 802.11× and includes a broadband wireless modem using EVDO for connecting to the internet. In such an embodiment, mobile communicator 20 may also provide voice communication using VOIP.

Computing device 24 preferably provides for the execution of software code within mobile communicator 20. In one embodiment, computing device 24 includes an electronic processing device and one or more types of electronic memory. The electronic processing device may be any type of commercially available processing device including microprocessors, microcontrollers, host processors, controllers, and application specific integrated circuits (ASICs). The electronic processing device can execute various types of electronic instructions, such as software or firmware programs stored in the electronic memory. For instance, the processing device can be used to execute programs or process data that enables the communications method discussed herein. The electronic memory may be any type or types that provide for both long and short-term data and computer program storage. In one embodiment, computing device 24 includes RAM for short-term storage, and a hard disk for long-term storage.

Mobile communicator 20 provides voice communication with the aid of microphone 26 and speaker 28. Generally, microphone 26 and speaker 28 can be any suitable device capable of receiving/providing verbal or other auditory information through mobile communicator 20. In one embodiment, microphone 26 and speaker 28 are provided in a common telephone handset connected to mobile communicator 20. Alternatively, microphone 26 and speaker 28 may be speakerphone-type devices capable of communicating speech with a user within a vicinity of mobile communicator 20. In one embodiment, microphone 26 and speaker 28 are hands-free devices that can monitor and adjust to compensate for ambient noise and the volume of the user's voice. In such an embodiment, the microphone can adjust its sensitivity level to compensate for a user with a loud or quiet speaking voice or to compensate for the distance between the user and mobile communicator 20. And speaker 28 can also adjust its volume accordingly.

Video camera 30 provides a real-time video feed from the user 12 and is preferably a digital video system, such as a webcam or digital video camera. In one embodiment, video camera 30 is a robotic webcam that includes features such as zoom, pan, and tilt that may be controlled by the user 12 or support technician 14. For example, video camera 30 may be a robotic webcam that includes an electric motor that provides for pan and tilt functionality. Video camera 30 may also provide for both optical and digital zoom functions. In one embodiment, video camera 30 is a pan/tilt IP network camera that includes an internal webserver such that the support technician 14 can also control the zoom, pan, and tilt of the camera.

Power supply 32 provides power for mobile communicator 20. In one embodiment, power supply 32 is an internal rechargeable battery that enables wireless communication without the need for external power and provides for complete portability. Power supply 32 may also simply be a power cord receptacle that allows the device to be plugged into convention electrical outlets.

### Remote Assistance Methods—

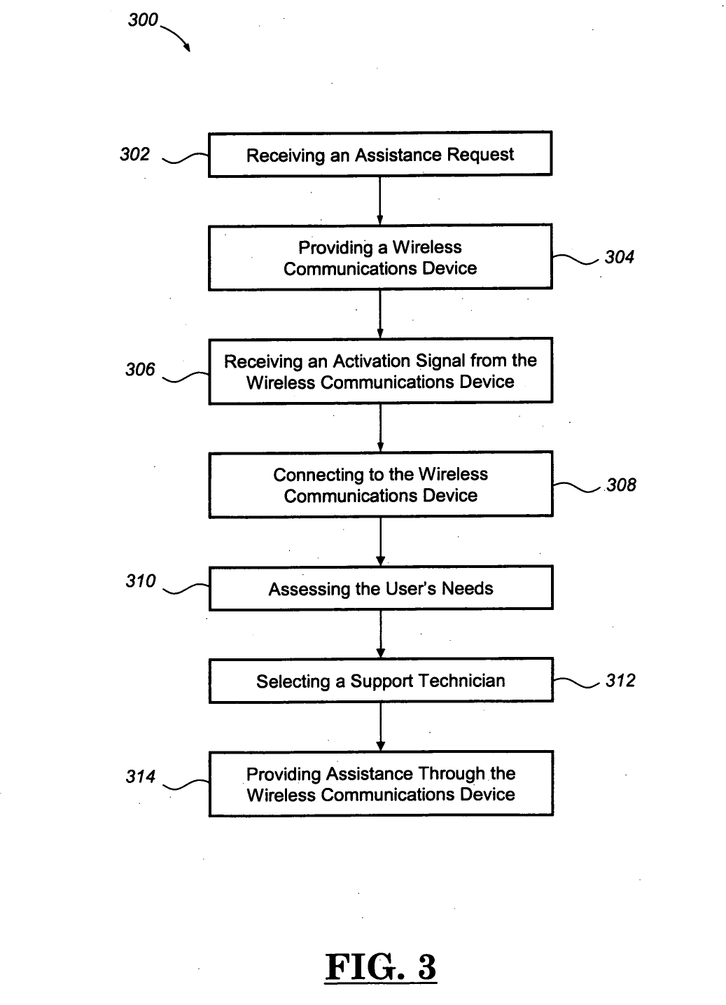

Referring now to FIG. 3, method 300 begins by receiving an assistance request from user 12, step 302. In one embodiment, a home improvement retail store may receive an assistance request from a customer during checkout or sale finalization. For example, the customer may purchase materials for a home improvement project 16 and may request assistance from the store. User 12 may be attempting a do-it-yourself (DIY) project 16 and may desire assistance for any number of reasons. For instance, the user may be unfamiliar with the tools, proper material handling, project management, or may simply feel that they would like to rely on professional or knowledgeable assistance during the project.

User 12 may then be provided with a wireless communications device, such as mobile communicator 20, step 304. Mobile communicator 20 is preferably capable of providing real-time voice and video communications, for example, real-time 2-way voice and 1-way video communication. Mobile communicator 20 may be provided to user 12 in a variety of ways, including having user 12 borrow or check-out one mobile communicator 20 from a home improvement retail store after purchasing items and submitting an assistance request. The home improvement store may have a plurality of mobile communicators 20 that can be lent to customers. In another embodiment, wireless communicators 20 may be provided to user 12 from a third party that is responsible for loaning out the devices. Once the device is provided to user 12, the user may take the device to any remote location. For example, user 12 may take the device home to receive remote assistance for a home improvement project 16.

An activation signal may then be received from the wireless communications device at step 306. In a preferred embodiment, the activation signal is automatically sent from mobile communicator 20 after the device is powered on. The activation signal may also be sent manually by pressing a button or control switch on the device. The activation signal may provide one or more functions including: registering the device with a DDNS service; alerting support technician 14 or server 70 that the device is active; altering a status message for the device in a database; or initiating an email, text, or SMS message. In one embodiment, the activation signal is received by server 70, which provides DDNS services and a website displaying the status of a plurality of mobile communicators 20. Server 70 registers the IP address and provides domain name/IP address resolution for the device. The domain name is likely a fully qualified domain name (FQDN) associated with the device. In another embodiment, server 70 receives the activation signal from mobile communicator 20, which is generated automatically after mobile communicator 20 is powered on by user 12. Server 70 then can send a notification message to support technician 14, where the notification message includes information about user 12, local project 16, and/or mobile communicator 20. For example, the notification message may include the IP address or FQDN of the device; the user's personal information; the user's specific needs or questions; or a status message.

After receiving an activation signal from mobile communicator 20, the device may then receive a connection at step 308. In one embodiment, support technician 14 connects directly to mobile communicator 20 after an activation signal is received by server 70. Support technician 14 may connect to mobile communicator 20 through the internet, or over land network 50 and wireless network 40. In one embodiment, mobile communicator 20 is connected to wireless network 40 over a broadband data channel such as EVDO. Mobile communicator 20 provides an internal webserver that allows support technician 14 to view a video feed from video camera 30 and to conduct a voice conversation with the user using microphone 26 and speaker 28.

In the disclosed embodiment, the user's needs are assessed at step 310. User 12 may communicate with server 70 or operator 18, where server 70 or operator 18 screens the calls in order to provide user 12 with an appropriate support technician 14. Operator 18 may reside at a central call center that facilitates requests from a plurality of users utilizing a plurality of mobile communicators 20. The assessment may be done by a preset automated menu, where user 12 punches or speaks an appropriate number or response. This may take place at server 70, which can then direct the assistance request to support technician 14. Alternately, operator 18 may be a live person who initially screens the calls and directs the calls to the appropriate support technician 14. Operator 18 may be a representative of a home improvement retail store located anywhere in the world. For example, operator 18 may connect to mobile communicator 20 over the internet land network 50, or wireless network 40, allowing operator 18 to converse with user 12. Operator 18 may ask questions about the user's skill level, the project involved, the materials, the progress of the project, and specific questions about the type of assistance that the user desires. Operator 18 may speak with user 12 and may view the user's work space through mobile communicator 20, which has camera 30 aimed at local project 16, allowing operator 18 to view local project 16 remotely. Operator 18 can then assess the type of assistance and the level of competency that user 12 requires. In one embodiment, operator 18 first determines the area of expertise that user 12 requires. In the example of a home improvement project, such areas of expertise may include: plumbing, electrical, roofing, building, decking, flooring, painting, tiling, kitchen, bathroom, and heating, ventilation, and air conditioning (HVAC). Operator 18 may then take an additional step of assessing the level of competency that a support technician must possess in order to properly assist user 12. For example, user 12 may only require a support technician 14 that is an entry level plumber to assist in a simple plumbing task. Or the user may require a support technician 14 that is a highly skilled and experienced HVAC technician to discuss a complex HVAC problem. In one example, operator 18 may learn that user 12 desires project quotations from a variety of contractors to perform a home improvement project.

After assessing the user's needs, operator 18 can select an appropriate support technician at step 312. In one embodiment, operator 18 may use a computer database to determine an appropriate and available support technician, where the database is provided by server 70. For example, operator 18 may search for an available support technician with entry-level plumbing experience using a database hosted by server 70. Once located, operator 18 or server 70 may send a notification message to support technician 14. The notification message may include the IP address or FQDN of mobile communicator 20; the user's personal information; the user's specific needs or questions; and/or a status message of the device. In one embodiment, operator 18 selects an appropriate support technician 14 and then server 70 automatically sends a notification message to support technician 14.

Once selected, support technician 14 can provide remote assistance to user 12 through system 10 at step 314. In one embodiment, support technician 14 provides one or more services, including: quoting a price for work to be done; providing step-by-step instructions; helping with tool selection; helping with material selection; providing cost estimation; aiding in problem solving; and discussing design options. Support technician 14 may be located anywhere in the world and connect to mobile communicator 20 through land network 50 and/or wireless network 40. In one embodiment, support technician 14 is a specialist working for a home improvement retail store. In another embodiment, support technician 14 is an independent contractor that provides remote assistance on behalf of a home improvement retail store from a remote location. Support technician 14 may be a single person or a support team working together to provide remote assistance to a user through a wireless communications device. In one embodiment, support technician 14 is comprised of multiple contractors located at various locations that may be attempting to provide work quotations for a user's home improvement project. When user 12 requests quotations from a variety of contractors, operator 18 at step 310 may select a group of contractors at step 312 and send the group a notification message. The group may be selected based on a variety of factors including location, project type, size, and contractor price and/or availability.

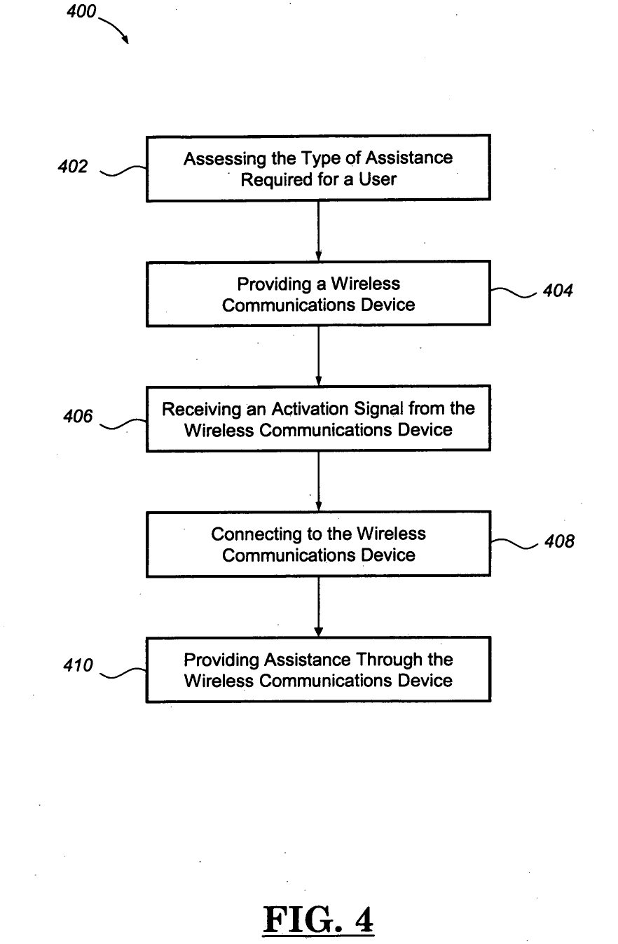

FIG. 4 illustrates another embodiment of a remote assistance method 400. Method 400 begins by assessing the type of assistance desired by user 12, at step 402. Like step 310, the needs of user 12 may be assessed by evaluating the user, the project, and the type of questions or assistance desired by the user. In one embodiment, a cashier at a home improvement retail store assesses the type of assistance requested by user 12 during a checkout procedure. In another embodiment, operator 18 assesses the user's needs over the telephone or over an internet website. User 12 may then be provided with mobile communicator 20 at step 404. Mobile communicator 20 may be provided by a home improvement retail store. An activation signal may then be received from mobile communicator 20 at step 406. In a preferred embodiment, mobile communicator 20 automatically sends an activation signal to server 70 after user 12 powers on the device. Once the activation signal is received, mobile communicator 20 may receive a connection at step 408. Support technician 14 may connect to the device over land network 50 and wireless network 40, or over an internet connection. Once connected, support technician 14 may provide remote assistance to user 12 over mobile communicator 20 at step 410.

The assistance request may come in many forms. User 12 may be required to specifically request assistance during checkout, and it may come at an additional fee. Or, the home improvement store may offer assistance as a free benefit, or to customers that purchase a pre-determined amount of merchandise. Also, the home improvement store may offer assistance to customers that purchase items from a pre-determined group of products, such as lighting fixtures, wall coverings, flooring, plumbing, electrical, gardening, and building supplies. In one embodiment, the user submits an assistance request in writing on a form, which may include personal information and project information. In another embodiment, the assistance request is an informal procedure where user 12 simply expresses interest in receiving remote assistance. In another embodiment, the assistance request is submitted by user 12 through an internet website. The assistance request may also be received by a third party. For example, a home improvement retail store may utilize the services of a third party to receive such requests and possibly provide other assistance-related services. The assistance request may also include additional information provided by user 12. Such additional information may include the user's personal information, home improvement project experience, specific project details, or details regarding the assistance request, such as a specific question or request for assistance dealing with a specific issue. In one embodiment, the assistance request includes the user's responses to a survey. The survey may be designed to gauge the user's home improvement project experience or to better understand the user's assistance needs.

Other variations and modifications are possible without departing from the scope and spirit of the present invention as defined by the appended claims.

The embodiments in which an exclusive property or privilege is claimed are defined as follows:

1. A method of providing real-time remote assistance comprising:
(a) a user having a wireless communications device that provides two-way audio communication and at least one way video communication to a remote assistance system;
(b) said remote assistance system receiving an activation signal from the wireless communications device;
(c) connecting to the wireless communications device to the remote assistance system, wherein the connection enables communication of both audio and video signals with the wireless communications device;
(d) assessing the user's needs;
(e) selecting a support technician to meet the user's needs; and
(f) placing the technician in audio communication directly with the user, wherein the technician can also view the video signal from the wireless communications device through the remote assistance system.

2. The method of claim 1, wherein the method provides real-time remote assistance to a plurality of users, wherein each user has a wireless communications device from a plurality of technicians connected to the remote assistance system.

3. The method of claim 1, wherein the wireless communication device is received by the user during a check-out procedure in a retail store.

4. The method of claim 1, wherein step (a) further comprises loaning the wireless communications device to the user.

5. The method of claim 1, wherein the wireless communications device is a mobile communicator that includes a webcam having pan, tilt, and zoom capabilities.

6. The method of claim 1, wherein the activation signal of step (b) is received by a server that registers the wireless communications device with a DDNS service.

7. The method of claim 1, wherein the activation signal of step (b) causes a notification message to be sent to the support technician.

8. The method of claim 7, wherein the notification message includes at least one information item from a group comprising: personal user information, user assistance request, an IP address, a FQDN, and a status message.

9. The method of claim 1, wherein step (c) further comprises connecting to the wireless communications device through the internet to the remote assistance system.

10. The method of claim 1, wherein step (d) further comprises speaking with the user, viewing the user's work space, and assessing the type of assistance and the level of competency that the user requires.

11. The method of claim 1, wherein step (e) further comprises selecting a support technician by an area of expertise and a competency level.

12. The method of claim 11, wherein the area of expertise is selected from a group comprising: plumbing, electrical, roofing, building, decking, flooring, painting, tiling, kitchen, bathroom, and HVAC.

13. The method of claim 1, wherein the support technician of step (f) provides remote assistance to the user through a mobile communicator.

14. The method of claim 1, wherein the support technician of step (f) provides a service from a group comprising: quoting a price for work to be done, providing step-by-step instructions, helping with tool selection, helping with material selection, providing cost estimation, aiding in problem solving, and discussing solution alternatives.

15. The method of claim 5 further comprising:
powering said wireless communication device with a battery pack stored therein.

16. The method of claim 1 further comprising:
powering said wireless communication device with a battery pack stored therein.
